(19) United States
(12) Patent Application Publication
(10) Pub. No.: US 2013/0032110 A1
(43) Pub. Date: Feb. 7, 2013

(54) SEALING COLLAR

(71) Applicants: Pascal David, Beidweiler (FR); Alain Carriere, Bousse (FR); Pierre Kimus, Attert (BE)

(72) Inventors: Pascal David, Beidweiler (FR); Alain Carriere, Bousse (FR); Pierre Kimus, Attert (BE)

(73) Assignee: DELPHI TECHNOLOGIES, INC., TROY, MI (US)

(21) Appl. No.: 13/642,157

(22) PCT Filed: Apr. 7, 2011
(86) PCT No.: PCT/EP2011/055403

§ 371 Date: Oct. 19, 2012

(30) Foreign Application Priority Data
Apr. 21, 2010 (FR) 1053032

(51) Int. Cl. F01L 1/34; B21K 3/00; F16L 21/06

(52) U.S. Cl. 123/90.16; 285/420; 29/888.01

(57) ABSTRACT

A sealing collar is provided on a body in which the body has a cylindrical wall on which a hole emerges and a fluid situated in the body is able to escape through the hole. The sealing collar includes a fixing band entirely surrounding the cylindrical wall. The fixing band has a sealing portion to sealedly obturate the hole and a means for closing and tightening the fixing band. The fixing band is provided with at least one claw extending in the direction of the cylindrical wall so that on closing and tightening of the fixing band around the cylindrical wall, the hole is sealedly obturated and the claw is pressed against the cylindrical wall and contributes to immobilizing the sealing collar on the body.

### TECHNICAL FIELD

The invention relates to an arrangement comprising a cylindrical body provided with a hole through which a fluid can escape and a collar which can be fitted to the cylindrical body so as to sealedly obturate the hole.

### TECHNOLOGICAL BACKGROUND OF THE INVENTION

Certain machines comprising a cylindrical body are provided with an emerging radial hole. This hole is used during the assembly or maintenance of the machine. A tool is inserted from the outside permitting the placing in position or indexing of the internal components of the machine. Where a fluid circulates in the machine the assembly hole must necessarily be sealed before commissioning.

To do this, a metal tightening collar is fitted around the cylindrical body, the band of the collar passing over the hole. The collar is then tightened around the body of the machine and the band of the collar obturates the hole. However, this type of system operates in an environment subject to vibrations, large variations in temperature or pressure, it happens that the collar loosens slightly but sufficiently to be displaced relatively to the cylindrical body. In this case, the fluid-tightness of the hole is no longer ensured and a leak can occur.

This is the case, for example, with certain hydraulic camshaft phasers for internal combustion engines. Such phasers comprise a stator driven in rotation by the engine and a rotor driven in rotation by the stator and rigidly attached to the camshaft; the angular position of the rotor inside the stator being adjustable during operation by means of a pressurised fluid. The stator is provided with an emerging radial hole used during assembly for the insertion of a tool for indexing the rotor relative to the stator, the tool keeping the phaser in a selected position.

### SUMMARY OF THE INVENTION

The present invention solves the problem described above by proposing the arrangement of a sealing collar tightened around the cylindrical body of the machine to be sealed.

The invention also proposes a process for ensuring the fluid-tightness of a machine.

The invention proposes long-term and sealed obturation of the hole by arranging on the cylindrical body a collar provided with at least one claw directed towards the body. When the collar is tightened, the claw is pressed against the body and makes a mark in the cylindrical wall of the body thus attaching the collar to the cylindrical body. The connection of the collar to the body is therefore advantageously provided both by the tightening and by the claw.

In the particular case of a body continuously subjected to a highly stressful environment, such as a camshaft phaser for a motor vehicle, the environment including vibrations, temperature variations, shocks, fluid under variable pressure, etc . . . , micro-displacements of the collar relatively to the body are possible. Also this double connection has the advantage that the collar remains in place without micro-displacement and the hole remains sealedly obturated.

More precisely, the invention relates to the arrangement of a sealing collar on a body. The body has a cylindrical wall on which a hole emerges, a fluid situated inside the body being able to escape through the hole. The sealing collar has a fixing band entirely surrounding the cylindrical wall, the band having a portion intended to sealedly obturate the hole. The collar is also provided with a means for closing and tightening the fixing band.

The fixing band is provided with at least one claw extending in the direction of the cylindrical wall so that on closing and tightening of the fixing band around the cylindrical wall, the hole is sealedly obturated and the claw is advantageously pressed against the cylindrical wall and contributes to immobilising the collar on the body. The portion of the fixing band intended to obturate the hole has no claw so as not to risk a leak.

More precisely, the claw extends from an edge of the fixing band.

It is possible to provide a plurality of claws on the band.

The invention also relates to a machine comprising a cylindrical body in which there is a fluid, the body being provided with an emerging radial hole. The machine also comprises a collar for sealing the hole, the arrangement of the collar on the body being in accordance with the characteristics above.

More precisely the machine is an angular camshaft phaser for an internal combustion engine.

The invention also relates to a process for ensuring the fluid-tightness of a cylindrical body in which there is a fluid. The body is provided with an emerging radial hole through which the fluid can escape. The process comprises the following steps:
arranging around the body a sealing collar as described above, so that the sealing portion of the fixing band entirely covers the hole to be obturated and also so that the claw, or the claws, are orientated towards the cylindrical body,
closing and tightening the collar around the cylindrical body so that the claw or claws are pressed against the body and contribute to immobilising the collar on the body.

The process for producing the collar comprises the following steps:
forming a band from a suitable material, such as steel, the band having a sufficient length to entirely surround the cylindrical body for which the collar is intended, and having in addition a portion intended to obturate the hole, the portion having a sufficient width to entirely cover the hole to be obturated;
forming along the band, outwith the portion intended to sealedly obturate the hole, at least one slantwise cut extending from the edge of the band towards the inside of the band, without exceeding half its width, and thus forming at least one acute angle sector on the side of the band;
bending the acute angle sector so as to form a claw relative to the band and, in the case of a plurality of cuts, bending all the acute angle sectors on the same side of the band so as to orientate all the claws in the direction of the cylindrical body;
associating the band with a closing and tightening means.

### BRIEF DESCRIPTION OF THE DRAWINGS

An embodiment of the invention is now described using the following figures:

FIG. 1 is a perspective view of a camshaft phaser provided with a hole used for indexing of the components during assembly;

FIG. 2 is a perspective view of a sealing collar in accordance with the invention; and

FIG. 3 is an overall view of the arrangement in accordance with the invention, the sealing collar of FIG. 2 being installed to tighten on the phaser of FIG. 1.

### DESCRIPTION OF THE PREFERRED EMBODIMENTS

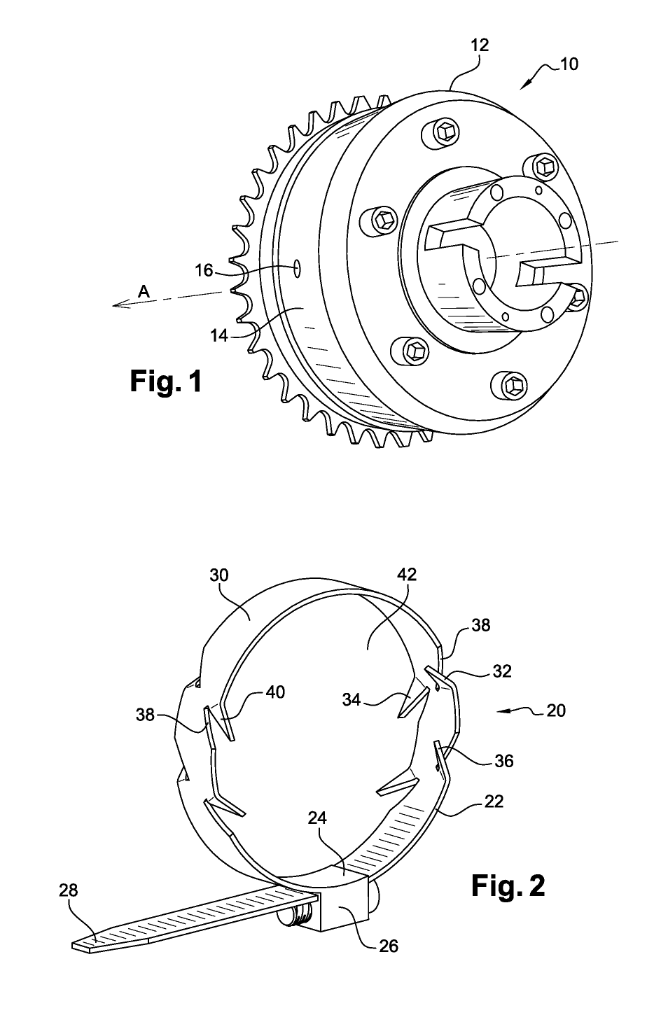

FIG. 1 shows a hydraulic camshaft phaser 10 comprising a stator 12 and a rotor positioned in the stator 12. The stator 12 is provided with a cylindrical wall 14 in which radially emerges a hole 16. During the assembly steps, a specific tool (not shown) can be inserted in the hole 16 so as to keep the rotor indexed relatively to the stator 12.

Once placed in position on a combustion engine, the phaser 10 operating with a fluid under pressure circulating in the stator 12, the hole 16 must necessarily be sealedly obturated.

FIG. 2 shows a sealing collar 20 in accordance with the invention. The collar 20 comprises a metal band 22 having a first end 24 provided with a closing and tightening device 26 and a second free end 28. The metal band 22 is curved on itself so that the free end 28 meets the closing device 26. Thus, the collar 20 forms a closed loop the inner diameter of which can be adjusted to that of the phaser 10.

The closing and tightening device 26 shown is a screw mechanism. Other known systems can be used alternatively such as, for example, hook systems.

The metal band 22 includes a portion 30 designed to be placed on the hole 16 and stop it. This portion 30 of the band is of sufficient width to entirely obturate the hole 16. FIG. 2 shows a collar 20 the band 22 of which is of uniform width equal to that of the sealing portion 30. A possible alternative is to select different widths for the sealing part 30 and the ends 24, 28. A progressive transition between the different widths is desirable, but not obligatory, so as to avoid zones of stress concentration.

The metal band 22 of FIG. 2 is provided with claws 32, 34, 36, situated outwith the sealing portion. A possible alternative is a collar 20 only having one claw 32. Such as shown in FIG. 2, the claws 32, 34, 36 have been formed after a partial cut 38 of the band 22. Each cut 38 extends from one of the sides of the band towards the inside of this but does not exceed half the width of the band 22. The cut 38 is slanting so as to form an acute angle sector 40 which is then bent in the form of a claw 32, 34, 36 towards the inside 42 of the loop of the collar 20. FIG. 2 presents a collar 20 provided with a plurality of claws 32, 34, 36 thus formed and it is important that all the claws 32, 34, 36 are bent towards the inside of the loop 42. As shown in FIG. 2, while all being bent towards the inside of the loop 42, the claws can be orientated in opposite directions such as the claws 34 and 36.

A possible alternative (not shown) is to make the collar 20 from a flat band 22 toothed on its sides, then to bend in the direction of the inside of the loop 42 the teeth which are outwith the sealing portion 30.

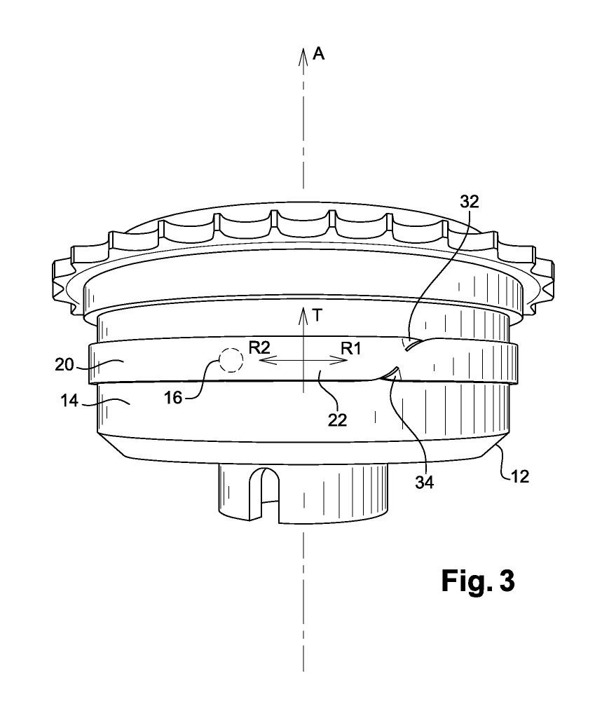

FIG. 3 shows the arrangement of the sealing collar 20 of FIG. 2 on the hydraulic phaser 10 of FIG. 1. In this arrangement, the collar 20 is tightened on the cylindrical wall 14 so that the sealing portion 30 of the collar 20 obturates the hole 16. The claws 32, 34, 36 of the collar 20 are pressed against the cylindrical wall 14 and make a mark in it. Thus the claws 32, 34, 36 ensure the position of the collar 20 and prevent any displacement of the collar 20 relatively to the stator 12. Such displacements would risk causing a leak by unstopping the hole 16.

The envisaged displacements of the collar 20 are either a translation by simple sliding parallel with the main axis A of the cylindrical wall 14, or a rotation R1, R2 about the main axis A of the cylindrical wall 14, or the combination of translation T with a rotation R1, R2. The rotation being able to be performed in a first direction R1 or in the opposite direction R2. The claws 32, 34, 36 all oppose the translation T of the collar 20, however one claw 32, 34, 36 opposes a rotation R1, R2 the more because the latter will tend to cause the claw 32, 34, 36 to penetrate the stator 12. It is therefore advantageous, but not essential, to provide claws 32, 34, 36 orientated in opposite directions such as the claws 34 and 36 of FIG. 2.

1. An arrangement of a sealing collar on a body in which the body has a cylindrical wall on which a hole emerges, a fluid situated in the body being able to escape through the hole, the sealing collar comprising:
a fixing band entirely surrounding the cylindrical wall, the fixing band having a sealing portion to sealedly obturate the hole,
a means for closing and tightening of the fixing band, and
at least one claw extending from the fixing band in the direction of the cylindrical wall so that on closing and tightening of the fixing band around the cylindrical wall, the hole is sealedly obturated and the claw is pressed against the cylindrical wall and contributes to immobilising the collar on the body.

2. An arrangement as described in claim 1 in which the sealing portion of the fixing band has no claw.

3. An arrangement as described in claim 1 in which the claw extends from an edge of the fixing band.

4. An arrangement as described in claim 1 in which the fixing band is provided with a plurality of claws.

5. A machine comprising a cylindrical body containing a fluid, the body being provided with an emerging radial hole, the machine also comprising a collar for sealing the hole, the collar comprising:
a fixing band entirely surrounding the cylindrical body, the band having a sealing portion to sealedly obturate the hole,
a means for closing and tightening of the fixing band, and
at least one claw extending from the fixing band in the direction of the cylindrical wall so that on closing and tightening of the fixing band around the cylindrical body, the hole is sealedly obturated and the claw is pressed against the cylindrical body and contributes to immobilising the collar on the cylindrical body.

6. A machine as described in claim 5 wherein the machine is an angular camshaft phaser for an internal combustion engine.

7. A process for ensuring the fluid-tightness of a cylindrical body in which there is a fluid, the body being provided with an emerging radial hole through which the fluid can escape, the process comprising the steps of:
providing a sealing collar having a fixing band with a sealing portion, a means for closing and tightening of the fixing band, and at least one claw extending from the fixing band,
arranging the sealing collar around the body so that the sealing portion of the fixing band entirely covers and obturates the hole and also so that the claw is orientated towards the cylindrical body,
closing and tightening the sealing collar around the cylindrical body so that the claw, pressed against the body contributes to immobilising the sealing collar on the body.

8. A process as described in claim 7 further comprising the following steps:
forming the fixing band from a suitable material having a sufficient length to entirely surround the cylindrical body and the sealing portion having a sufficient width to entirely cover the hole;
forming along a portion of the fixing band without the sealing portion at least one slantwise cut extending from the edge of the fixing band towards the inside of the fixing band without exceeding half of its width, and thus forming at least one acute angle sector on the side of the band;
bending the acute angle sector so as to form the claw relative to the band; and
associating the fixing band with a closing and tightening means.

9. A machine as described in claim 5 in which the sealing portion of the fixing band has no claw.

10. A machine as described in claim 5 in which the claw extends from an edge of the fixing band.

11. A machine as described in claim 5 in which the fixing band is provided with a plurality of claws.
